(19) United States
(12) Patent Application Publication
(10) Pub. No.: US 2024/0241926 A1
(43) Pub. Date: Jul. 18, 2024

(54) SYSTEMS AND METHODS FOR AUTOMATIC MATTER CLASSIFICATION AND EXTRACTION OF DATA

(71) Applicant: RELX Inc., Miamisburg, OH (US)

(72) Inventor: Joseph Hunt, Miamisburg, OH (US)

(73) Assignee: RELX Inc., Miamisburg, OH (US)

(21) Appl. No.: 18/411,684

(22) Filed: Jan. 12, 2024

Related U.S. Application Data
(60) Provisional application No. 63/479,696, filed on Jan. 12, 2023.
(60) Provisional application No. 63/479,699, filed on Jan. 12, 2023.

(51) Int. Cl. G06F 18/2415; G06F 40/174

(52) U.S. Cl. CPC G06F 18/2415; G06F 40/174

(57) ABSTRACT

Systems and methods for automatic extraction of electronic data are disclosed. In one aspect, a method of automatically generating a matter form, the method includes receiving input data from one or more sources, the input data relating to a matter, classifying, using a trained model, a matter classification based at least in part on the input data, selecting one or more matter forms based on the matter classification, automatically extracting field data from the input data, and automatically populating fields of the one or more matter forms with the extracted field data.

### CROSS-REFERENCE TO RELATED APPLICATIONS

This application claims priority to U.S. Provisional Application Nos. 63/479,696 and 63/479,699 filed on Jan. 12, 2023 and entitled “Automatic Matter Intake Form Suggestion at Time of Matter Request Creation” and “Automatic Matter Creation from Emails,” respectively, both of which are incorporated by reference in their entireties.

### BACKGROUND

In many industries, such as the legal industry, matter intake forms are used to describe and provide information about a new matter. In the legal context, a matter intake form may include fields for information such as client name, matter title, matter description, NAICS code, and the like. The type of matter may have specific information that is needed. For example, a litigation matter will have different informational requirements than a patent matter. A litigation matter may have a plaintiff field, a defendant field, a complaint type field, docket due dates, and the like. A patent matter may have a bar date field, an invention type field, inventor fields, and the like.

It can be cumbersome for matter intake personnel to both determine the appropriate matter intake form for the incoming matter, as well as to fill out the various fields of the form with all of the relevant information describing the matter. Completing these matter intake forms is laborious and takes significant time.

Accordingly, alternative systems and methods for completing matter intake forms are desired.

### BRIEF SUMMARY

In one embodiment, a method of automatically generating a matter form includes receiving input data from one or more sources, the input data relating to a matter, classifying, using a trained model, a matter classification based at least in part on the input data, selecting one or more matter forms based on the matter classification, automatically extracting field data from the input data, and automatically populating fields of the one or more matter forms with the extracted field data.

In another embodiment, a computing apparatus includes a processor. The computing apparatus also includes a memory storing instructions that, when executed by the processor, configure the apparatus to receive input data from one or more sources, the input data relating to a matter, classify, using a trained model, a matter classification based at least in part on the input data, select one or more matter forms based on the matter classification, automatically extract field data from the input data, and automatically populate fields of the one or more matter forms with the extracted field data.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system for automatically completing matter intake forms according to one or more embodiments described and illustrated herein.

FIG. 2 illustrates an example graphical user interface for automatically completing matter intake forms according to one or more embodiments described and illustrated herein.

FIG. 3 illustrates an example system for automatically classifying a matter according to one or more embodiments described and illustrated herein.

FIG. 4 illustrates an example system for automatically completing one or more matter intake forms according to one or more embodiments described and illustrated herein.

FIG. 5 illustrates a flowchart of an example method for automatically completing one or more matter intake forms according to one or more embodiments described and illustrated herein.

FIG. 6 illustrates an example computing system for automatically completing one or more matter intake forms according to one or more embodiments described and illustrated herein.

### DETAILED DESCRIPTION

Embodiments of the present disclosure are directed to systems and methods for automatically classifying a matter type and automatically completing one or more matter intake forms based on the matter type upon matter intake by extracting field data from input data. Generally, embodiments include receiving input data regarding a new matter, and automatically classifying the new matter into a matter classification based on the input data. One or more matter intake forms are selected based on the matter classification. Field data is then automatically extracted from the input data and populated into relevant fields of the one or more matter intake forms. The matter intake forms can then be used for downstream processes.

By automatically classifying the matter and auto-populating the fields of the relevant matter intake form(s), significant time and resources are saved. Personnel can instead perform other tasks.

Various embodiments of systems and methods for automatically completing matter intake forms are described in more detail below.

Although embodiments are described herein in the context of legal matter intake forms, embodiments are not limited thereto. Embodiments may be utilized in any field where matter intake forms are used, such as medical, construction, interior design, web design, consulting, and the like.

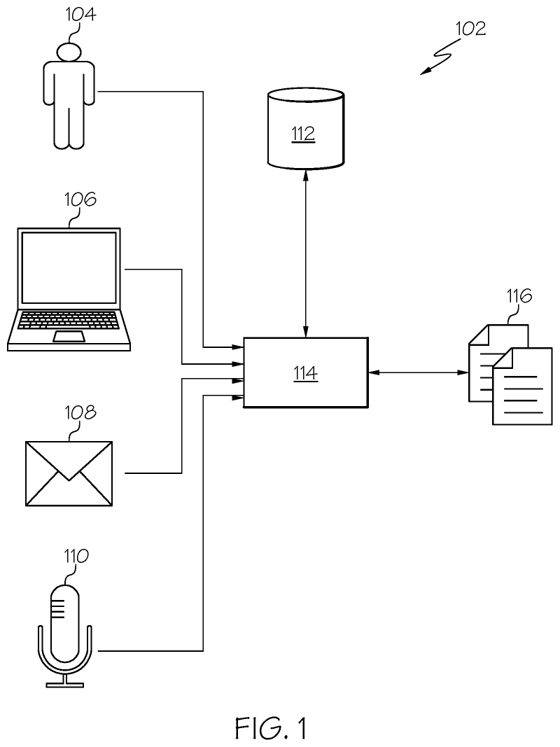

Referring now to FIG. 1, an example system 102 for automatically filling out matter intake forms 116 is schematically illustrated. It should be understood that embodiments are not limited to the configuration of FIG. 1 and that more or fewer elements may be provided. Generally, the system 102 includes various input data sources 104-110 that provide input data to a matter intake form generator 114. As described in more detail below, the matter intake form generator 114 includes one or more trained models to both detect the matter classification and automatically complete one or more matter intake forms 116 based on the input data.

The input data sources may take on a variety of different forms. In the illustrated example, the input data sources include a chat bot 104, a text input 106, an electronic file input 108, and a spoken input 110. These various input data sources provide input data relating to a new matter that has been received into an organization, such as a new legal matter. The input data is used to classify the matter and complete one more matter intake forms 116 relating to the matter. The user may use the one or more input data source to provide information relating to the matter. In some embodiments, the input data comprises user data, such as position title, historical matters handled, queries and the like. The user data can be used by the system to more accurately predict the type of matter based on past matters.

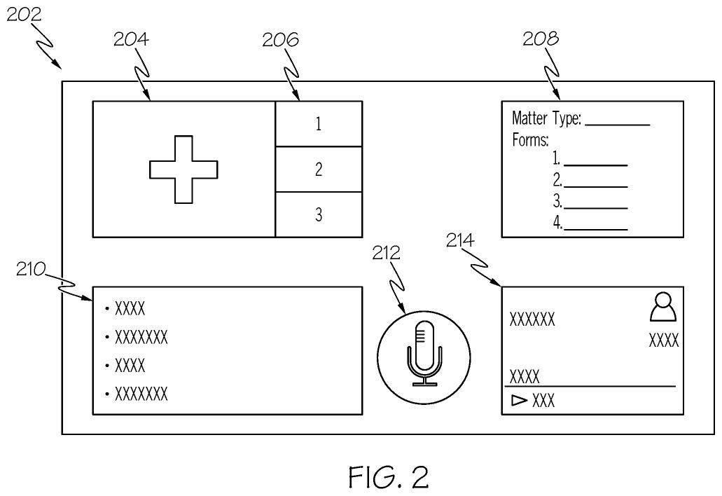

The input data sources 104-110 may be provided in a computer software application that is accessible to the user. FIG. 2 illustrates an example user interface 202 of a software application that is configured to complete matter intake forms 116. The user interface 202 may be a component of a standalone software application product, or it may be a plug-in feature of a larger software application tailored to a particular field (e.g., a legal research software program).

The example user interface 202 includes a chat bot interface 214 that provides chat bot 104 functionality for the user to provide input data regarding the particular matter. The chat bot interface 214 may utilize any known or yet-to-be-developed chat bot model for prompting questions and obtaining information. The chat bot model may be trained on various different matters and to produce relevant questions and statements to elicit the requisite input data from the user. The chat bot 104 may be further trained on historic data, such as previous queries.

The user may ask the chat bot various queries pertaining to a matter, such as legal queries of a legal matter. In the legal context, if the user's query can have its resolution automated by referencing internal legal policy documentation, the user is provided with search results for the given query. When the chat bot identifies that the user is indicating a need to submit a legal request (i.e., user's intended result cannot be automated), it will respond and ask the user to describe the needed legal task.

For example, if the user asks a question regarding elements of submitting a contract request, for example, a non-disclosure agreement, the chat bot 104 may ask for description of what the user needs. The chat bot then supplies an appropriate matter intake form for the user. In some embodiments, the chat bot 104 asks questions of the user relating to information that is still needed to include in a matter intake form.

The user interface 202 also include a file import interface 204 for the user to import electronic files relevant to the new matter. Thus, the file import interface 204 provides an interface for the electronic file input 108 illustrated in FIG. 1. The user may drag-and-drop relevant files into the file import interface 204, or use another means to import the electronic files. Electronic files that are inputted are then listed in an imported files list 206 for review by the user. The user can take various actions regarding the files in the imported files list 206, including opening files, deleting the files, prioritizing the files (e.g., moving them up and down in the list).

As a non-limiting example, one of the electronic files may be an email. The email may be from a client describing a new matter as one example. As another example, the email may be from an organization member to person or matter intake department that describes the new matter in natural language. For example, the email may include language such as “We received a new patent infringement law suit from Client X where they are being sued by Company Y for alleged infringement of Patent No. X0,135,126. The patent is for a dog chew toy . . . . ” As described in more detail below, the matter intake form generator 114 receives the email and uses its text as input data to classify the matter and complete one or more matter intake forms.

Other electronic documents may also be imported using the file import interface 204, such as a legal complaint, other legal documents, company profiles, and the like. These electronic documents may also be used as input data by the matter intake form generator 114.

The user interface 202 of FIG. 2 also includes a text box 210 that is provided for a user to add free-form text regarding the new matter. The user may type in natural language sentences, fragments, words, and the like into the text box 210. No particular formatting is needed. The text box 210 may be used in lieu of the chat bot 104 if the user is familiar with what type of information is needed for the matter intake form generator 114. For example, the user may type in “client: company X; matter: wrongful death; plaintiff: company Y; new client: yes; field: nautical;” and the like into the text box 210. The matter intake form generator 114 receives this data and may use it to classify the matter and complete one or more matter intake forms as described in more detail below.

A microphone button 212 is provided to give the user the ability to use spoken language to provide input data into the system. When the user selects the microphone button 212, the computer software program accesses a microphone of the computer (e.g., desktop computer, laptop computer, smart phone, tablet, and the like). The user can then speak into the microphone (not shown) to describe the new matter that has come in. The user can speak in natural language sentences, or in fragments such as in the wrongful death example above, to describe the new matter. The system may include a speech-to-text algorithm to convert the spoken language into text that is then used by the matter intake form generator 114 to classify the new matter and complete the one or more matter intake forms 116.

Referring again to FIG. 1 and as described in more detail below, the matter intake form generator 114 receives input data from one or more input data sources 104-110 and uses it to classify the matter and to complete one or more matter intake forms 116. The matter intake form generator 114 accesses a matter data storage 112 for data relevant to performing its functions, such as historical data, matter data, and any other data needed.

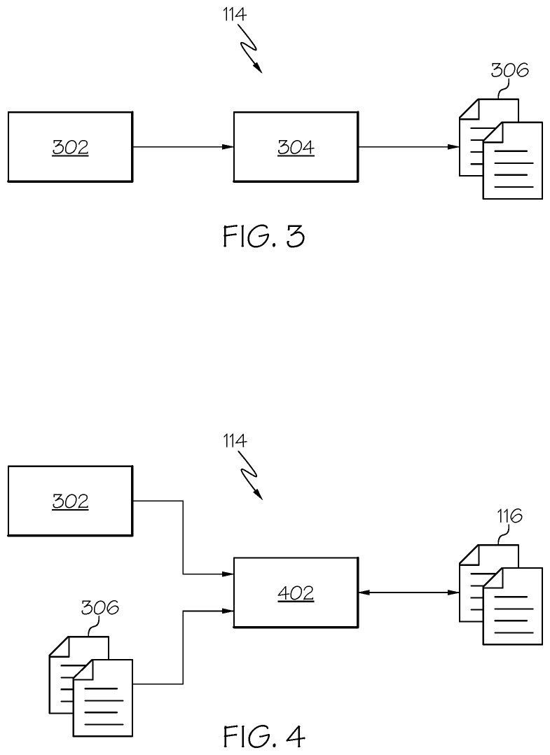

Referring now to FIG. 3, a portion of the system 102 for classifying the matter is illustrated. The matter intake form generator 114 may include a matter classifier 304, which may be a trained classifier that is trained to receive the input data 302 and output a matter classification (e.g., merger, patent infringement, real estate closing, etc.). The matter classifier 304 may be a supervised classifier such as, without limitation, a support vector machine, K-nearest neighbors, Naive Bayes, and logistic regression. The trained classifier is trained to output a matter classification based on input data describing the matter. Embodiments are not limited by the type or number of classifications.

Using the wrongful death example from above, the user may have submitted an email from the client describing the nature of the law suit into the file import interface 204, and also may have inputted various facts regarding the matter into the text box 210, or provided spoken dialogue using the microphone button 212. The trained classifier receives this input data 302 and outputs one or more matter classifications. In this example, the matter is “litigation.”

Sub-matters classifications may also be generated, such as “wrongful death,” or a specific matter classifications may be generated, such as “litigation—wrongful death.”

The one or more matter classifications that are outputted by the matter classifier 304 may be displayed in a suggested forms region 208, as shown in FIG. 2. In this way, the user can be confident that the system properly classified the matter. If any changes need to be made, the user may make a change to the matter classification in the suggested forms region 208.

The matter classifier 304 outputs one or more blank matter intake form 306 as shown in FIG. 3. The one or more blank matter intake forms 306 may be listed in the suggested forms region 208. A user can select a listed matter intake form from the suggested forms region 208 to open it, save it, or otherwise interact with it. The user may opt to fill out the one or more matter intake forms manually, or in some embodiments automatically without human input. There may be a user interface element that the user may select to cause a selected matter intake form to be automatically filled out using field data extracted from the input data.

Referring now to FIG. 4, a portion of the system for automatically filling in (i.e., completing) one or more blank matter intake forms 306 is illustrated. The matter intake form generator 114 includes a field data extractor 402 that is operable to extract field data from the input data and populate the extracted field data into the appropriate fields of the one or more blank matter intake forms 306. In some embodiments, the field data extractor 402 extracts data from the input data 302 by searching its contents for text matching an intake field's predefined formula, then imports that data into the matter type's associated intake form. Each field of the blank matter intake form 306 has a data formula defined for data extraction (for example, a Contract matter type has the intake form field “contract value”. This field's data formula defines the appropriate contents to be of the formats “$xxx,xxx {x=numeric variable}”, “xx,xxx$”, “yyyyyy-yyyyyyyy {y=free text variable} dollars”, etc. Text in the input data 302 matching those criteria is assigned a data type label for extraction).

In other embodiments, the field data extractor 402 comprises a large language model that is operable to receive the input data 302 and the one or more blank matter intake forms 306 or a list of the fields of the one or more blank matter intake forms 306. The system provides a prompt to the large language model for it to extract the fields from the one or more blank matter intake forms 306, and to find field data within the input data 302 that matches the fields. In embodiments where only the fields are provided as input to the large language model rather than the blank matter intake forms 306 themselves, the prompt may be configured to ask the large language model to find the field data within the input data 302 that matches the provided fields. The output of the large language model may be field-field data pairs. The field data extractor 402 may further include a script that takes the field-field data pairs and populates the fields of the one or more blank matter intake forms 306 with the field data extracted from the input data 302.

The end result is one or more populated matter intake forms 116. These forms can be used for downstream purposes, such as, without limitation, providing legal representation, performing medical care based on the data in the matter intake forms 116, creating a work (e.g., a website, an advertisement, an artwork), generating software code (e.g., generating a software program per requirements of the matter intake form), building a structure (e.g., building a house or renovating a building based on requirements of the matter intake form).

As a specific example, once a matter intake form is completed, the system then submits that completed matter intake form as a matter within the workflow tool for review and assignment. A legal matter may be any inquiry or dispute regarding the rights or obligations of a party in relation to an agreement. In embodiments, legal matter management may refer to a set of activities to be completed a company's legal department. In other embodiments, the system may be used to generate matter forms for any business group and is not limited to legal matters. For example, the system or method may extract data from an email, classify the data for a matter and populate a matter intake form.

In some embodiments, the matter intake forms are computer readable and may be automatically transmitted to a machine to autonomously perform an automated physical task, such as an autonomous vehicle that autonomously navigates an environment, or a three-dimensional printer that fabricates an article automatically per the field data of the matter intake form.

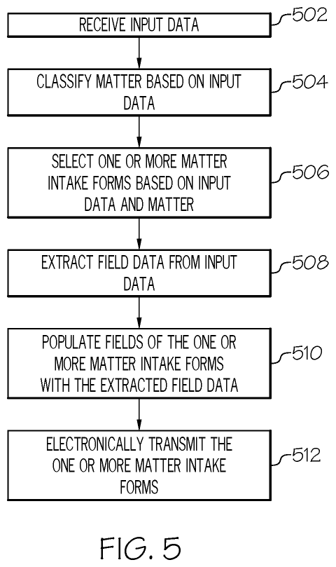

Referring now to FIG. 5, a method for completing one or more matter intake forms is illustrated. At block 502, input data related to a new matter is received by the system. The input data may be generated by any method, such as natural speech, use of a chat bot, imported electronic files, and free text. Next, at block 504 a matter is classified using the input data and a matter classifier of a matter intake form generator 114. From the classified matter, one or more relevant matter intake forms are selected at block 506. These forms may be selected from a repository of forms stored in a data storage device, for example.

At block 508 field data is extracted from the input data. The field data is data that is relevant to fields of the one or more matter intake forms that are selected at block 506. In the legal context, field data may include client name, adverse party NAISC codes, amount at controversy, and the like. A field data extractor is configured to extract the field data from the input that is provided by the user. Next, at block 510 the selected one or more matter intake forms are populated with the field data that was extracted at block 508. Now the system has created populated matter intake forms that are ready for downstream processes, such as transmitting the one or more matter intake forms to desired persons/entities at block 512.

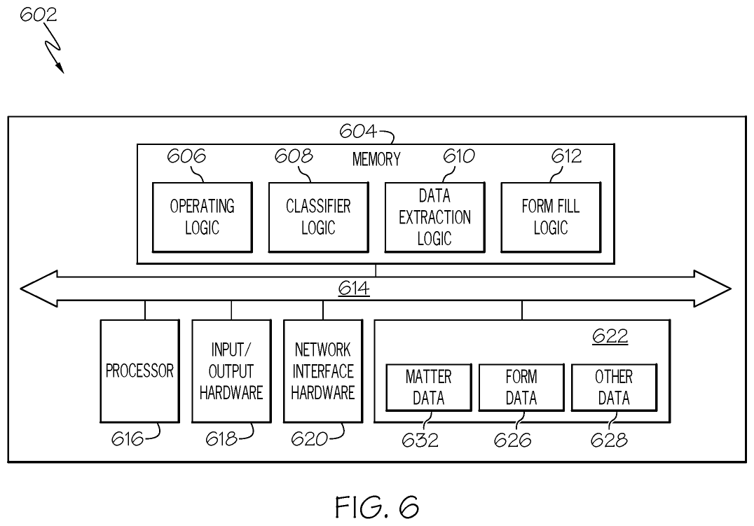

Embodiments of the present disclosure may be implemented by a computing device, and may be embodied as computer-readable instructions stored on a non-transitory memory device. Referring now to FIG. 6, an example system for automatically generating matter intake forms as a computing device 602 is schematically illustrated. The example computing device 602 provides a system for automatically generating matter intake forms, and/or a non-transitory computer usable medium having computer readable program code for automatically generating matter intake forms embodied as hardware, software, and/or firmware, according to embodiments shown and described herein. While in some embodiments, the computing device 602 may be configured as a general purpose computer with the requisite hardware, software, and/or firmware, in some embodiments, the computing device 602 may be configured as a special purpose computer designed specifically for performing the functionality described herein. It should be understood that the software, hardware, and/or firmware components depicted in FIG. 6 may also be provided in other computing devices external to the computing device 602 (e.g., data storage devices, remote server computing devices, and the like).

As also illustrated in FIG. 6, the computing device 602 (or other additional computing devices) may include a processor 616, input/output hardware 618, network interface hardware 620, a data storage component 622 (which may store matter data 624 (e.g., data relating to matter classifications, previous matter data, and the like), form data 626 (e.g., data relating to the various forms), and any other data 628 for performing the functionalities described herein), and a non-transitory memory component 604. The memory component 604 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 604 may be configured to store operating logic 606, classifier 608 for automatically classifying input data of a new matter into a matter classification, data extraction logic 610 for extracting field data from the input data, and form fill logic 612 for filling one or more matter forms with the extracted field data as described herein (each of which may be embodied as computer readable program code, firmware, or hardware, as an example). It should be understood that the data storage component 622 may reside local to and/or remote from the computing device 602, and may be configured to store one or more pieces of data for access by the computing device 602 and/or other components.

A local interface 614 is also included in FIG. 6 and may be implemented as a bus or other interface to facilitate communication among the components of the computing device 602.

The processor 616 may include any processing component configured to receive and execute computer readable code instructions (such as from the data storage component 622 and/or memory component 604). The input/output hardware 618 may include virtual reality headset, graphics display device, keyboard, mouse, printer, camera, microphone, speaker, touch-screen, and/or other device for receiving, sending, and/or presenting data. The network interface hardware 620 may include any wired or wireless networking hardware, such as a modem, LAN port, wireless fidelity (Wi-Fi) card, WiMax card, mobile communications hardware, and/or other hardware for communicating with other networks and/or devices

Included in the memory component 604 may be the operating logic 606, classifier logic 608, data extraction logic 610, and form fill logic 612. The operating logic 606 may include an operating system and/or other software for managing components of the computing device 602. Similarly, the classifier logic 608 may reside in the memory component 604 and may be configured to automatically classify the matter of input data into a matter classification. The data extraction logic 610 also may reside in the memory component 604 and may be configured to automatically extract relevant field data from the input data based on the matter classification. The form fill logic 612 includes logic to automatically fill one or more matter intake forms with the extracted field data.

The components illustrated in FIG. 6 are merely exemplary and are not intended to limit the scope of this disclosure. More specifically, while the components in FIG. 6 are illustrated as residing within the computing device 602, this is a non-limiting example. In some embodiments, one or more of the components may reside external to the computing device 602.

It should now be understood that embodiments of the present disclosure are directed to systems and methods for automatically classifying matters (e.g., legal matters) into a matter classification, and automatically filling one or more matter intake forms with relevant data extracted from input data describing a new matter. The input data can take a variety of forms, such as electronic documents (e.g., emails), spoken language, free text, and interactions with a chat bot. Field data is automatically extracted from the input data by a model, such as a large language model, and used to populated the one or more matter intake forms. The process saves time and resources to produce the matter intake forms over traditional methods.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of automatically generating a matter form, the method comprising:
receiving input data from one or more sources, the input data relating to a matter;
classifying, using a trained model, a matter classification based at least in part on the input data;
selecting one or more matter forms based on the matter classification;
automatically extracting field data from the input data; and
automatically populating fields of the one or more matter forms with the extracted field data.

2. The method of claim 1, wherein the trained model is a classifier model.

3. The method of claim 2, wherein the trained model is further configured to convert the input data into a plurality of vectors.

4. The method of claim 1, wherein the trained model is a large language model.

5. The method of claim 1, wherein the trained model is further configured to perform the step of automatically extracting the field data.

6. The method of claim 1, wherein the input data is provided in the form of one or more of spoken natural language, an interaction with a chat bot, and one or more electronic documents.

7. The method of claim 6, wherein the method further comprises converting the spoken natural language to text using a speech-to-text algorithm.

8. The method of claim 6, wherein the chat bot is operable to prompt questions regarding a matter type.

9. The method of claim 6, wherein the one or more electronic documents comprises one or more emails.

10. The method of claim 1, wherein the input data further comprises user demographic data.

11. A computing apparatus comprising:
a processor; and
a memory storing instructions that, when executed by the processor, configure the apparatus to:
receive input data from one or more sources, the input data relating to a matter;
classify, using a trained model, a matter classification based at least in part on the input data;
select one or more matter forms based on the matter classification;
automatically extract field data from the input data; and
automatically populate fields of the one or more matter forms with the extracted field data.

12. The computing apparatus of claim 11, wherein the trained model is a classifier model.

13. The computing apparatus of claim 12, wherein the trained model is further configured to convert the input data into a plurality of vectors.

14. The computing apparatus of claim 11, wherein the trained model is a large language model.

15. The computing apparatus of claim 11, wherein the trained model is further configured to perform the step of automatically extract the field data.

16. The computing apparatus of claim 11, wherein the input data is provided in the form of one or more of spoken natural language, an interaction with a chat bot, and one or more electronic documents.

17. The computing apparatus of claim 16, wherein the process is further configured to convert the spoken natural language to text using a speech-to-text algorithm.

18. The computing apparatus of claim 16, wherein the chat bot is operable to prompt questions regard a matter type.

19. The computing apparatus of claim 11, wherein the one or more electronic documents comprises one or more emails.

20. The computing apparatus of claim 11, wherein the input data further comprises user demographic data.
